(19) United States
(12) Patent Application Publication
(10) Pub. No.: US 2006/0169505 A1
(43) Pub. Date: Aug. 3, 2006

(54) Drive system for a motor vehicle having a hybrid drive

(75) Inventors: Panagiotis Adamis, Wolfsburg (DE); Jens Hilbig, Vollbuttel (DE)

Correspondence Address: LERNER GREENBERG STEMER LLP, P O BOX 2480, HOLLYWOOD, FL, 33022-2480, US

(73) Assignee: Volkswagen AG

(21) Appl. No.: 11/346,485

(22) Filed: Feb. 2, 2006

(30) Foreign Application Priority Data
Feb. 2, 2005 (DE) 10 2005 004 737.8

(51) Int. Cl. B60K 6/00

(52) U.S. Cl. 180/65.2

(57) ABSTRACT

A drive system for a motor vehicle with a hybrid drive, having an internal combustion engine, at least one electric machine, and a transmission. The transmission is embodied as a twin-clutch manual transmission and has two input shafts which are each coupled to the crankshaft of the internal combustion engine. The operative connection between the input shafts of the twin-clutch manual transmission and the assigned electric machine can be switched to an inoperative state on demand. This is achieved by virtue of the fact that the electric machine is operatively connected by way of a separate clutch in such a way that this electric machine can alternatively be coupled to or be detached from the drivetrain formed between the internal combustion engine, the first section of the input shaft, the clutch assigned to the input shaft, the second section of the input shaft and the transmission.

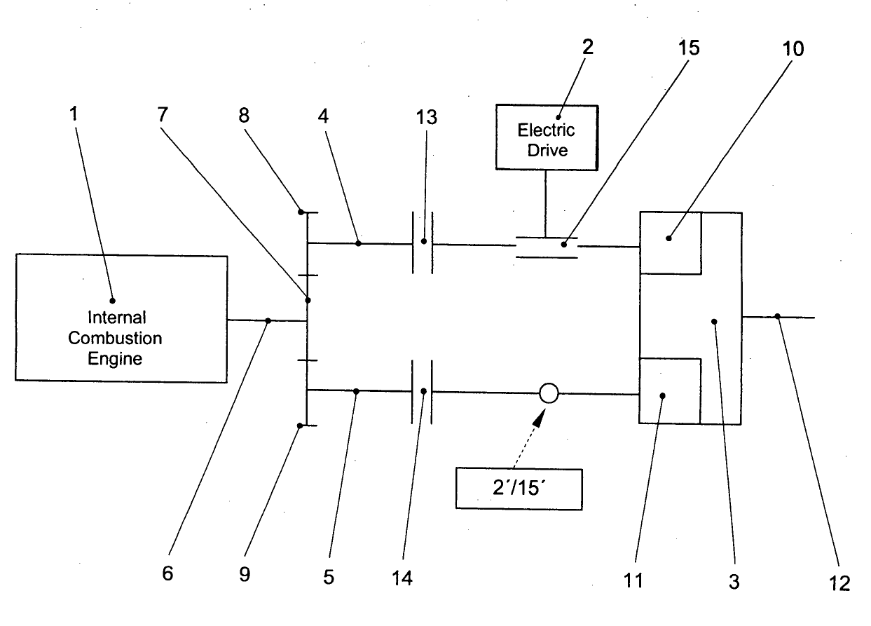

### BACKGROUND OF THE INVENTION

### Field of the Invention

The invention relates to a drive system for a motor vehicle having a hybrid drive, comprising an internal combustion engine, at least one electric machine, and a transmission. The transmission is embodied as a twin-clutch manual transmission and has two input shafts which are each coupled to the crankshaft of the internal combustion engine. Gear wheel groups for transmission functions can be coupled to an output shaft for the traction drive. Each input shaft is assigned a clutch between the internal combustion engine and the gear wheel groups in order to couple the internal combustion engine to the output shaft. At least one of the input shafts is operatively connected to the at least one electric machine.

With conventional gasoline or diesel engines having been used for decades as a drive unit for motor vehicles, it is increasingly sought, particularly due to environmental criteria, to use novel drive concepts. In this case, in addition to the utilization of alternative fuels, hybrid drives having two different drive units are also realized. Such hybrid drives predominantly have an internal combustion engine and an electric machine. The internal combustion engine ensures high performance capability and range. The electric machine allows zero-emission driving, the achievable drive performance and the driving distance which can be covered, however, being limited. By way of example, during cross-country driving, the vehicle is driven by the internal combustion engine and the batteries are charged, and during city driving, the vehicle is driven by the battery-fed electric machine.

German published patent application DE 101 15 984 A1 and its counterpart United States Patent Application Publication US 2002/0183154 A1 describe a drive system for a motor vehicle driven by an internal combustion engine and having a transmission and an electric machine which is embodied as a starter, is connected to the drivetrain shaft or is arranged parallel to the latter and is preferably integrated in a hybrid drive. In addition to its starter function, the electric machine can, by means of pole reversal, realize two opposing rotational directions and hence forward and reverse gears without a mechanical reverse gear set being required in the vehicle transmission for this purpose.

A motor vehicle having a hybrid drive formed from an internal combustion engine and an electric machine is described in U.S. Pat. No. 6,823,954 B2 and in its related German published patent application DE 102 21 844 A1. There, the electric machine is connected by way of a hydraulic clutch to an output shaft of the internal combustion engine and also to a transmission in order to transmit a torque to the drive wheels of the vehicle. During the operation of the internal combustion engine, the electric machine is driven by the latter and works as a generator which charges the battery. As an alternative, the electric machine works as an electromotive drive when it is supplied with battery current. In the event of a switch from a driving mode driven by the electric machine to a driving mode driven by the internal combustion engine, the drive torques of the electric machine and the internal combustion engine act together for at least a short period, so that at such operating points, the overall drive torque for the vehicle increases abruptly. This increase acts on the vehicle occupants as a kick and ultimately adversely affects the overall driving behavior. Such disadvantages should be avoided by means of a control system which is proposed in this document and which reduces the kick when the clutch is engaged during the switch between the different drive units.

U.S. Pat. No. 6,712,734 B1 and its related European patent EP 1 127 230 B1 describe a motor vehicle having a hybrid drive in which the transmission is embodied as a twin-clutch manual transmission having two input shafts which are coupled to the crankshaft of the internal combustion engine. The input shafts are each assigned gear wheel groups with which the transmission functions are realized. Furthermore, the two input shafts can be coupled to an output shaft which either forms the drive shaft for the traction drive or leads to a drive shaft related to the latter. In order to couple the internal combustion engine to the output shaft by means of the input shafts, each input shaft is assigned a clutch between the internal combustion engine and the gear wheel groups. Furthermore, at least one of the two input shafts is coupled in a non-positive manner to an electric machine. This electric machine, which is arranged between the clutch and the gear wheel groups of the transmission, assumes the functions of the starter and of the generator and can otherwise be used as a hybrid drive unit.

An embodiment of this type of a hybrid drive having a twin-clutch manual transmission, which is also referred to as a “parallel hybrid concept,” has been fundamentally proven. It is however disadvantageous that there is a non-positive operative connection between the electric machine and the input shaft in all operating states. This can result in the driving comfort being adversely affected at certain operating points. While this aspect can be neglected, the fuel demand which inevitably arises as a result of this operative connection is however problematic.

### SUMMARY OF THE INVENTION

It is accordingly an object of the invention to provide a drive system for a motor vehicle with hybrid drive, which overcomes the above-mentioned disadvantages of the heretofore-known devices and methods of this general type and wherein the operative connection between the input shafts of the twin-clutch manual transmission and the assigned electric machine can be switched to an inoperative state on demand.

With the foregoing and other objects in view there is provided, in accordance with the invention, a drive system for a motor vehicle having a hybrid drive, comprising:

an internal combustion engine having a crankshaft;

an electric machine;

a twin-clutch manual transmission having two input shafts each coupled to the crankshaft of the internal combustion engine and having gear wheel groups for transmission and coupling to an output shaft for driving the motor vehicle;

a clutch connected in each one of the input shafts between the internal combustion engine and the gear wheel group for coupling the internal combustion engine to the output shaft; and

a further clutch operatively connected between the at least one electric machine and a drivetrain formed between the internal combustion engine and the output shaft for selectively coupling and decoupling the electric machine from the drivetrain.

In other words, the objects of the invention are achieved by virtue of the fact that the electric machine is operatively connected by means of a separate clutch in such a way that this electric machine can alternatively be coupled to or be detached from the drivetrain formed between the internal combustion engine, the first section of the input shaft, the clutch assigned to the input shaft, the second section of the input shaft and the transmission.

In contrast to previously conventional parallel hybrid concepts having a maximum of two clutches, an additional third clutch is now used, by means of which an electric machine installed between the internal combustion engine and the twin-clutch manual transmission can be decoupled from the internal combustion engine. As a result, only an operative connection is then produced instead of a rigid non-positive connection between the electric machine and the input shaft, as long as the respective specific operating state of the motor vehicle requires this. This embodiment leads to low fuel consumption with excellent driving comfort.

In accordance with an added feature of the invention, drivetrain is formed by a first portion of one of the input shafts, the clutch connected in the one input shaft, a second portion of the one input shaft, and the transmission.

In accordance with an additional feature of the invention, the electric machine is a single electric machine operatively connected to the input shaft by way of the further clutch. Alternatively, there are provided two electric machines for the hybrid drive and two further clutches. In that case, each of the two electric machines is operatively connected to a respective one of the input shafts by way of a respective one of the further clutches.

Other features which are considered as characteristic for the invention are set forth in the appended claims.

Although the invention is illustrated and described herein as embodied in a drive system for a motor vehicle having a hybrid drive, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawing.

### BRIEF DESCRIPTION OF THE DRAWING

The drawing figure is a schematic diagram of an exemplary embodiment of the invention.

### DESCRIPTION OF THE PREFERRED EMBODIMENT

Referring now to the sole figure of the drawing in detail, the drive system according to the invention for a motor vehicle having a hybrid drive comprises an internal combustion engine 1, an electric machine 2, and a transmission 3. The transmission 3 is embodied as a twin-clutch manual transmission and has two input shafts 4 and 5. The input shafts 4 and 5 are each coupled to the crankshaft 6 of the internal combustion engine 1. This coupling can for example be by way of an annular gear 7 which is arranged on the crankshaft 6 and is brought into engagement with a gear wheel 8, 9 respectively, on each of the respective input shafts 4 and 5.

Furthermore, the input shafts 4 and 5 each have a gearwheel group 10 and 11, by means of which the functions in the transmission 3 can be realized. The transmission 3 also has an output shaft 12 for the traction drive so that the input shafts 4 and 5 are operatively connected to the traction drive by way of the transmission 3. In order for the internal combustion engine 1 to be coupled to the output shaft 12 for the traction drive, the input shafts 4 and 5 are each assigned a respective clutch 13 and 14 between the internal combustion engine 1 and the respective gear wheel groups 10 and 11. Furthermore, at least one of the input shafts 4 or 5 is operatively connected to at least one electric machine 2.

This type of construction of a drive system having a hybrid drive is known per se, so that further discussion of the functionality is not required at this point. In the present circumstances, it is however significant that the electric machine 2 is assigned an additional separate clutch 15. By means of this clutch 15, the electric machine 2 installed between the internal combustion engine 1 and the twin-clutch manual transmission 3 can be selectively operatively connected to the internal combustion engine 1. The additional clutch 15 consequently allows for the electric machine 2 to alternatively be coupled to or be detached from the drivetrain formed between the internal combustion engine 1, the first section of the input shaft 4, the clutch 13 assigned to the input shaft 4, the second section of the input shaft 4 and the transmission 3.

In the embodiment illustrated in the drawing, the hybrid drive has just one electric machine 2 which is operatively connected to the input shaft 4 by way of the additional separate clutch 15. It is likewise possible for the hybrid drive to be embodied with two electric machines 2 and 2′. In that case, the second electric machine 2′ is assigned to the input shaft 5. An additional separate clutch 15′, by means of which a detachable operative connection is realized between the electric machine 2′ and the input shaft 5, is also provided here. An embodiment of this type is represented in a stylized manner in the drawing by an arrow and the reference symbols 2′ and 15′.

This application claims the priority, under 35 U.S.C. § 119, of German patent application No. 10 2005 004 737.8, filed Feb. 2, 2005; the entire disclosure of the prior application is herewith incorporated by reference.

We claim:

1. A drive system for a motor vehicle having a hybrid drive, comprising:
an internal combustion engine having a crankshaft;
an electric machine;
a twin-clutch manual transmission having two input shafts each coupled to said crankshaft of said internal combustion engine and having gear wheel groups for transmission and coupling to an output shaft for driving the motor vehicle;
a clutch connected in each one of said input shafts between said internal combustion engine and said gear wheel group for coupling said internal combustion engine to the output shaft; and
a further clutch operatively connected between said at least one electric machine and a drivetrain formed between said internal combustion engine and the output shaft for selectively coupling and decoupling said electric machine from said drivetrain.

2. The drive system according to claim 1, wherein said drivetrain is formed by a first portion of one of said input shafts, said clutch connected in said one input shaft, a second portion of said one input shaft, and said transmission.

3. The drive system according to claim 1, wherein said electric machine is a single electric machine operatively connected to said input shaft by way of said further clutch.

4. The drive system according to claim 1, wherein said electric machine is one of two electric machines of the hybrid drive and said further clutch is one of two further clutches, and wherein each of said two electric machines is operatively connected to a respective one of said input shafts by way of a respective one of said further clutches.
